(19) United States
(12) Patent Application Publication
(10) Pub. No.: US 2004/0067762 A1
(43) Pub. Date: Apr. 8, 2004

(54) Method and device for entering text

(76) Inventor: Henrik Balle, Copenhagen V. (DK)

Correspondence Address: PERMAN & GREEN, 425 POST ROAD, FAIRFIELD, CT, 06824, US

(21) Appl. No.: 10/434,055

(22) Filed: May 8, 2003

(30) Foreign Application Priority Data
Oct. 3, 2002 (FI) FI 20021759

(51) Int. Cl. H04Q 7/20

(52) U.S. Cl. 455/466; 455/566

(57) ABSTRACT

A method of text entry in a mobile communication device includes highlighting a representation of a key on a display and scrolling through a predetermined sequence of representations of a plurality of keys and highlighting one of the representations. If the device is operating in a first mode, the method includes selecting the highlighted representation of a key, generating a key identifier sequence, and providing the key identifier sequence as input to a software application which associates each key identifier sequence with a set of words whose spellings correspond to the key identifier sequence and which presents on the display at least one word whose spelling corresponds to the input key identifier sequence. If the device is operating in a second mode, the method includes selecting a character of the set of characters associated with the highlighted representation of a key, and presenting the selected character on the display.

### FIELD OF THE INVENTION

Embodiments of the invention relate to a method and a device for entering text. They particularly relate to hand portable devices that use a non-keypad input device for text entry instead of a keypad input device.

### BACKGROUND TO THE INVENTION

Hand-portable electronic devices, for instance subscriber terminals in a radio system, such as mobile cellular telephones, are becoming smaller and smaller. At some point the standard keypad of a device, for instance the 12-button character keypad used in mobile cellular telephones, will become useless since it becomes too difficult for a user to press buttons that are extremely small. The size of keypad will stars to restrict the design of hand-portable electronic devices. If the keypad could be replaced by another input device, it would be possible to manufacture hand-portable devices of a smaller size, even of miniature size.

A special problem with the use of a hand-portable electronic device is the process of entering text. For instance, in ordinary mobile telephones employing a character keypad, each button in the keypad relates to several letters. A single button may, for instance, relate to the letters a, b and c. Pressing the button once produces the letter a, pressing the button twice within a short threshold period of time produces the letter b, and pressing the button three times within a short threshold period of time produces the letter c. Pressing the button twice slightly more slowly i.e. with a hiatus greater than the threshold produces two a's. It is rather slow to use a keyboard in such a manner; therefore, various methods for entering text which employ a 12 button character keyboard have been developed. One such a method uses predictive/disambiguating text software such as “T9” by Tegic Communications. The functionality of “T9” is described in U.S. Pat. No. 5,818,437 (Tegic Communications), titled “Reduced Keyboard Disambiguating Computer”, the contents of which are incorporated herein by reference.

It would be desirable to replace the character keypad by another non-keypad user input device and still provide for user input of text.

Some mobile telephones employ a solution wherein a user may browse a character string which includes the entire character set of the device, for instance in an alphabetical order, the characters then being selected one by one from this character string. The solution is rather slow, so different solutions have been provided thereto in publication Mobile Text Entry Using Three Keys by I. Scott MacKenzie, Proceedings of the Second Nordic Conference on Human Computer Interaction, NordiCHI 2002. In the solutions of the publication, a character string containing an entire character set is arranged in an order other than an alphabetical one in order to accelerate the process of entering text.

It would be desirable to replace the character keypad by another non-keypad user input device and still provide improved input of text.

### BRIEF DESCRIPTION OF THE INVENTION

According to one embodiment there is provided a method of text entry in a device comprising a non-keypad user input device with a browsing mechanism and a selection mechanism, comprising the steps of:

a) presenting on a display one or more groups of characters wherein each group is associated with a different set of characters;

b) browsing using the non-keypad user input device to select a chosen group of characters;

c) generating an identifier sequence each time a group of characters is selected;

d) providing the identifier sequence as input to a database storing a plurality of identifier sequences and, associating with each identifier sequence, a set of words whose spellings correspond to the identifier sequence; and

e) presenting on the display at least one of the words from the set of words whose spelling corresponds to the inputted identifier sequence.

According to another embodiment there is provided a method of text entry in a device comprising a non-keypad text user input device with a rotating mechanism and a selection mechanism, comprising the steps of:

a) highlighting on a display a representation of a key of a keypad having a plurality of keys wherein each key is associated with a different set of characters and the displayed representation of any one of the plurality of keys identifies a portion of the set of characters associated with the one key;

b) scrolling using the rotating mechanism of the non-keypad text user input device through, on the display, a predetermined sequence of representations of the plurality of keys to highlight a chosen representation of one of the plurality of keys; then if the device is operating in a first user selected mode, in which a text disambiguating software application is used for text entry, performing the steps of:

i) selecting the highlighted representation of a key using the selection mechanism of the non-keypad text user input device;

ii) generating a key identifier sequence each time a highlighted representation of a key is selected; and

iii) providing the key identifier sequence as input to the text disambiguating software application which stores a plurality of key identifier sequences and, associates with each key identifier sequence, a set of words whose spellings correspond to the key identifier sequence and which presents on the display at least one of the words from the set of words whose spelling corresponds to the inputted key identifier sequence;

or, alternatively, if the device is operating in a second user selectable mode, performing the steps of:

i) selecting a character of the set of characters associated with the highlighted representation of a key using the non-keypad user input device; and

ii) presenting on the display the selected character.

According to another embodiment there is provided a method of text entry using a text disambiguating software application for a device with a key-pad user input device, in a device with a non-keypad user input device with a rotating dial and a selection mechanism, comprising the steps of:

a) highlighting on a display a representation of a key of a keypad having a plurality of keys wherein each key is associated with a different set of characters and the displayed representation of any one of the plurality of keys identifies a portion of the set of characters associated with the one key;

b) scrolling using the rotating dial of the non-keypad user input device through, on the display, a predetermined sequence of representations of the plurality of keys to highlight a chosen representation of one of the plurality of keys;

c) selecting the highlighted representation of a key using the selection mechanism of the non-keypad user input device;

d) generating a key identifier sequence each time a highlighted key is selected; and

e) providing the key identifier sequence as input to the text disambiguating software application which stores a plurality of key identifier sequences and, associates with each key identifier sequence, a set of words whose spellings correspond to the key identifier sequence and which presents on the display at least one of the words from the set of words whose spelling corresponds to the inputted key identifier sequence.

### BRIEF DESCRIPTION OF THE DRAWINGS

For a better understanding of the present invention and to understand how the same may be brought into effect reference will now be made by way of example only to the accompanying drawings illustrating exemplary embodiments of the invention, in which:

FIG. 1 schematically illustrates a hand-portable electronic device 10 for user text entry;

FIGS. 2A and 2B illustrate examples of non-keypad text user input devices

FIG. 3 illustrates a set of text characters divided into multiple groups of different characters

### DETAILED DESCRIPTION OF PARTICULAR EMBODIMENTS OF THE INVENTION

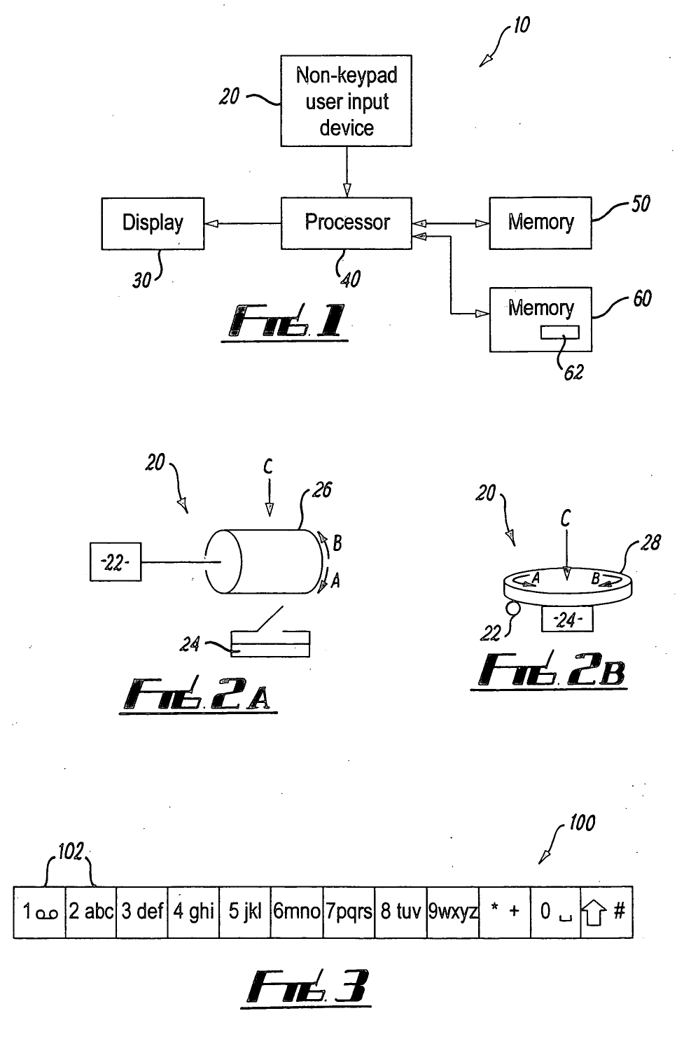

FIG. 1 schematically illustrates a hand-portable electronic device 10 for user entry of text. The hand-portable electronic device 10 fits comfortably within the palm of one hand and its man machine interface (MMI) is constrained because of the device's small size. Examples of hand-portable electronic devices include mobile cellular telephones and personal digital assistants (PDAs).

The illustrated hand-portable electronic device 10 includes a non-keypad user input device 20; a display 30; a processor 40; a first memory 50 and a second memory 60 containing a set 62 of computer program instructions for the processor 40. Although the first memory 40 and second memory 60 are illustrated and described as being separate memories, it should be appreciated that they may also be separate portions of the same memory chip and the division between the portions may be physical or logical.

Possible non-keypad user input devices 20 are illustrated in FIGS. “A and “B. The non-keypad user input device 20 is the main or only input device for text entry, it is therefore referred to as a non-keypad text user input device.

FIG. 2A shows one example of a non-keypad text user input device 20. The non-keypad user input device is a roller 26. A browsing/scrolling mechanism 22 enables browsing/scrolling commands to be issued to the processor 40 by discriminating rotation of the roller 26 around its axis. The roller can be rotated in both directions A and B. A selection mechanism 24 enables select commands to be issued to the processor 40 by discriminating a pressing of the roller 112 in a direction C. The NOKIA® 7110 mobile cellular telephone has a three-way roller in addition and not as an alternative to a 12 key character keypad.

FIG. 2B shows another example of a non-keypad text user input device 20. The non-keypad user input device is a rotator 28 such as a disc or dial. A browsing/scrolling mechanism 22 enables browsing/scrolling commands to be issued to the processor 40 by discriminating rotation of the rotator coplanarly clockwise and anti-clockwise. A selection mechanism 24 enables select commands to be issued to the processor 40 by discriminating a pressing of the rotator 28 in a direction C, alternatively a separate button may be provided for issuing select commands.

An further alternative non-keypad user text input device is a five-way joystick or a five-way roller device.

The first memory 50 stores predictive/disambiguating software for performing text disambiguation. This may for example be the “T9” software. The first memory 50 stores as a database a plurality of key identifier sequences and, associated with each key identifier sequence, a set of words whose spellings correspond to the key identifier sequence. The term “key identifier sequence” corresponds to the term as used in U.S. Pat. No. 5,818,437. The first memory 50 also stores a set of disambiguating computer program instructions that enable the processor 40 to disambiguate a key identifier sequence into a word. The processor 40, when so enabled, interrogates the database using a key identifier sequence and receives in reply all or some of the words in the set of words whose spellings correspond to the key identifier sequence and presents on the display one or more of the received words.

The first memory 50 may also contain associated with each set of words, whose spellings correspond to the sequence, an indication of which word in the set is most frequently used. and the processor may present on the display the most frequently used word corresponding to the key identifier sequence.

The set 62 of computer program instructions control the operation of the processor and the hand-portable device 10 as described below.

A set of text characters 100, in this case the English alphabet, is divided into multiple groups of three or four characters as illustrated in FIG. 3. Each group 102 of characters corresponds to one of the twelve keys of a character keypad of a prior art mobile cellular telephone. The characters assigned to particular keys varies from manufacturer to manufacturer. For Nokia the groups 102 of characters are: ‘2 abc’, ‘3 def’, ‘4 ghi’, ‘5 jkl’, ‘6 mno’, ‘7 pqrs’, ‘8 tuv’, ‘9 wxyz’, ‘*+’, ‘0 space’. The groupings are only an example and may be varied.

The processor 40 under the control of the set 62 of computer program instructions enables a user to select any one of the groups of characters. If the grouping of characters is the same as on the keys of a character keypad of a particular mobile cellular telephone, the output on selection of a group corresponds to the output from selection of key of a character keypad. Thus the predictive/disambiguating software used previously with that particular mobile cellular telephone can be re-used in the present hand-portable electronic device 10. If the grouping of characters is different, the predictive/disambiguating software is optimised for the particular grouping of characters used.

The processor 40 under the control of the set 62 of computer program instructions enables a user to select any one of the groups of characters. This may be achieved by first highlighting a particular one of the groups of characters using the scrolling/browsing mechanism 22 and then selecting the highlighted group using the selection mechanism 24.

In one embodiment, the groups of characters are arranged in a predetermined sequence as a continuous band that can be scrolled through a portion 32 of the display 34. The portion 32 may be able to simultaneously display one or more groups of characters. If only one group of characters can be displayed, its mere display in the portion 32 is enough to highlight the group. If more that one group of characters can be displayed simultaneously in the display 20 some additional form of highlighting is required. For example, a different color can be used to highlight one group. Preferably the groups of characters can be scrolled in a step-wise fashion.

The processor 40 can operate in two text input modes. In the first mode, text disambiguation is used, in the second mode it is not used. The user may select whether the processor 40 is operating in the first mode or the second mode and can change modes using the non-keypad user input device20.

When the processor is operating in the first mode, it responds to input via the selection mechanism 22 of the non-keypad text user input device 20 to select the highlighted group and it generates an identifier sequence each time a highlighted group is selected. The identifier sequence is provided as an input to a database storing a plurality of identifier sequences and, associating with each identifier sequence, a set of words whose spellings correspond to the identifier sequence. The database returns for presentation on the display at least one of the words from the set of words whose spelling corresponds to the inputted identifier sequence.

In the embodiment in which each group of characters corresponds to a representation of a key, the processor 40 responds to input via the selection mechanism 22 to select the highlighted representation of a key and generate a key identifier sequence. The key identifier sequence is provided as an input to the text disambiguating software application which stores a plurality of key identifier sequences and, associates with each key identifier sequence, a set of words whose spellings correspond to the key identifier sequence. The text/disambiguating software application presents on the display at least one of the words from the set of words whose spelling corresponds to the inputted key identifier sequence.

When the processor is operating in the second mode, it responds to input via the non-keypad user input device to select a character in the highlighted group of characters and present that character on the display. For example when the highlighted group of characters includes the characters a, b and c., pressing the selection mechanism 22 once presents the letter a, pressing the selection mechanism twice within a short threshold period of time presents the letter b, and pressing the selection mechanism three times within a short threshold period of time produces the letter c.

Although embodiments of the present invention have been described in the preceding paragraphs with reference to various examples, it should be appreciated that modifications to the examples given can be made without departing from the spirit and scope of the invention.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

What is claimed is:

1. A method of text entry in a mobile communication device comprising a non-keypad text user input device with a rotating mechanism and a selection mechanism, comprising the steps of:
a) highlighting on a display a representation of a key of a keypad having a plurality of keys wherein each key is associated with a different set of characters and the displayed representation of any one of the plurality of keys identifies a portion of the set of characters associated with the one key;
b) scrolling using the rotating mechanism of the non-keypad text user input device through, on the display, a predetermined sequence of representations of the plurality of keys to highlight a chosen representation of one of the plurality of keys;
then if the device is operating in a first user selected mode, in which a text disambiguating software application is used for text entry, performing the steps of:
i) selecting the highlighted representation of a key using the selection mechanism of the non-keypad text user input device;
ii) generating a key identifier sequence each time a highlighted representation of a key is selected; and
iii) providing the key identifier sequence as input to the text disambiguating software application which stores a plurality of key identifier sequences and, associates with each key identifier sequence, a set of words whose spellings correspond to the key identifier sequence and which presents on the display at least one of the words from the set of words whose spelling corresponds to the inputted key identifier sequence;
or, alternatively, if the device is operating in a second user selectable mode, performing the steps of:
i) selecting a character of the set of characters associated with the highlighted representation of a key using the non-keypad user input device; and
ii) presenting on the display the selected character.

2. A method of text entry using a text disambiguating software application for a device with a key-pad user input device, in a mobile communication device with a non-keypad user input device with a rotating dial and a selection mechanism, comprising the steps of:
a) highlighting on a display a set of characters from a plurality of different sets of characters where each of the displayed sets of characters identifies a portion of the characters included in the set of characters;
b) scrolling using the rotating dial of the non-keypad user input device through, on the display, a predetermined sequence of the different sets of characters to highlight a chosen set of characters;
c) selecting the highlighted set of characters using the selection mechanism of the non-keypad user input device;
d) generating an identifier sequence each time a highlighted set of characters is selected; and
e) providing the identifier sequence as input to the text disambiguating software application which stores a plurality of identifier sequences and, associates with each identifier sequence, a set of words whose spellings correspond to the identifier sequence and which presents on the display at least one of the words from the set of words whose spelling corresponds to the inputted identifier sequence.

3. A hand-portable mobile communication device for user entry of text comprising:
a non-keypad text user input device with a rotating mechanism and a selection mechanism;
a display;
a processor;
a first memory storing a plurality of key identifier sequences and, associated with each key identifier sequence, a set of words whose spellings correspond to the key identifier sequence;
a second memory containing a set of processor instructions which cause the processor:
to highlight on the display a representation of a key of a keypad having a plurality of keys wherein each key is associated with a different set of characters and the displayed representation of any one of the plurality of keys identifies a portion of the set of characters associated with the one key;
to respond to input via the rotating mechanism to scroll through on the display a predetermined sequence of representations of the plurality of keys and to highlight a chosen representation of one of the plurality of keys;
and, when the processor is operating in a first user selectable mode, cause the processor:
to respond to input via the selection mechanism of the non-keypad text user input device to select the highlighted representation of a key;
to generate a key identifier sequence each time a highlighted representation of a key is selected; and
to present on the display at least one of the words from the set of words whose spelling corresponds to the generated key identifier sequence;
and, when the processor is operating in a second user selectable mode, cause the processor:
to respond to input via the non-keypad text user input device to select a character of the set of characters associated with the highlighted key; and
to present on the display the selected character.

4. A hand portable mobile communication device as claimed in claim 3, wherein the first memory also contains associated with each set of words, whose spellings correspond to the sequence, an indication of which word in the set is most frequently used, and, when the processor is operating in the first user selectable mode, cause the processor to present the most frequently used corresponding to the generated key identifier sequence.

5. A method of text entry in a mobile communication device comprising a non-keypad user input device with a browsing mechanism and a selection mechanism, comprising the steps of:
a) presenting on a display one or more groups of characters wherein each group is associated with a different set of characters;
b) browsing using the non-keypad user input device to select a chosen group of characters;
c) generating an identifier sequence each time a group of characters is selected;
d) providing the identifier sequence as input to a database storing a plurality of identifier sequences and, associating with each identifier sequence, a set of words whose spellings correspond to the identifier sequence; and
e) presenting on the display at least one of the words from the set of words whose spelling corresponds to the inputted identifier sequence.

6. A method as claimed in claim 5 having as an alternative to steps c), d) and e) the steps of:
i) selecting one of the characters of the highlighted group of characters; and
ii) presenting on the display the selected character.

7. A method of text entry using a text disambiguating software application for a device with a key-pad text user input device, in a mobile communication device with a non-keypad text user input device, comprising the steps of:
a) presenting on a display one or more representations of the keys of a keypad having a plurality of keys wherein each key is associated with a different set of characters and the displayed representation of any one of the plurality of keys identifies at least a portion of the set of characters associated with the one key;
b) browsing using the non-keypad text user input device to select a chosen representation of one of the plurality of keys;
c) generating a key identifier sequence each time a highlighted representation of a key is selected; and
d) providing the key identifier sequence as input to the text disambiguating software application which stores a plurality of key identifier sequences and, associates with each key identifier sequence, a set of words whose spellings correspond to the key identifier sequence and which presents on the display at least one of the words from the set of words whose spelling corresponds to the inputted key identifier sequence.

8. A hand-portable mobile communication device for text entry comprising:
a non-keypad text user input device,
a display;
a processor;
a first memory storing a plurality of identifier sequences and, associated with each key identifier sequence, a set of words whose spellings correspond to the identifier sequence;
a second memory containing a set of processor instructions which cause the processor:
to present on the display one or more groups of characters wherein each group is associated with a different set of characters;
to respond to input via the non-keypad text user input device to enable browsing and selection of a chosen group of characters;
to generate an identifier sequence each time a group of characters is selected;
to provide the identifier sequence as input to a database storing a plurality of identifier sequences and, associating with each identifier sequence, a set of words whose spellings correspond to the identifier sequence; and
to enable presentation on the display at least one of the words from the set of words whose spelling corresponds to the inputted identifier sequence.

9. A storage medium embodying computer program instructions that cause a processor:
to highlight on a display a representation of a key of a keypad having a plurality of keys wherein each key is associated with a different set of characters and the displayed representation of any one of the plurality of keys identifies a portion of the set of characters associated with the one key;
to respond to a first user input command to scroll through on the display a predetermined sequence of representations of the plurality of keys and to highlight a chosen representation of one of the plurality of keys;
to respond to a second user input command to select the highlighted representation of a key;
to generate a key identifier sequence each time a highlighted representation of a key is selected; and
to enable presentation on the display of at least one word whose spelling corresponds to the generated key identifier sequence.
